(19) United States
(12) Patent Application Publication
(10) Pub. No.: US 2007/0113830 A1
(43) Pub. Date: May 24, 2007

(54) In-line type fuel supply device in fuel injection device

(75) Inventors: Yasuhiro Koito, Kawasaki-shi (JP); Masaki Aizawa, Kawasaki-shi (JP); Hidefumi Yoshida, Kawasaki-shi (JP)

Correspondence Address: BACON & THOMAS, PLLC, 625 SLATERS LANE, FOURTH FLOOR, ALEXANDRIA, VA, 22314, US

(73) Assignee: Keihin Corporation, Tokyo (JP)

(21) Appl. No.: 11/377,322

(22) Filed: Mar. 17, 2006

(30) Foreign Application Priority Data
Mar. 17, 2005 (JP) 2005-077001

(51) Int. Cl. F02M 37/04

(52) U.S. Cl. 123/509; 123/514

(57) ABSTRACT

To enhance pump ability and freedom of a device, a fuel discharge passage 8 is connected to a fuel injection valve J with a first fuel pipe 13, a second fuel pipe 14 branched from the first fuel pipe 13 is connected to a regulator fuel flow-in passage 55 of a pressure regulator R, a regulator fuel control hole 56 is connected to a fuel tank T with a third fuel pipe 15, a fuel flow-in chamber 6 at a lower part of the pump case 1 is connected to an upper part of the pump case 1 through a cylindrical space 9, the fuel flow-in chamber 6 is connected to the fuel tank T through a fuel flow-in pipe 12, and a vapor discharge hole 10 opened on an upper space 7 is connected to the fuel tank T through a fourth fuel pipe 16.

### BACKGROUND OF THE INVENTION

1. Field of the Invention

The present invention relates to a fuel injection device, in which fuel in a fuel tank is increased in pressure by a fuel pump, the fuel increased in pressure is regulated in pressure by a pressure regulator, and the fuel regulated in pressure is supplied toward a fuel injection valve. More particularly, the present invention relates to an in-line type fuel supply device, in which a fuel pump is provided at the outside of the fuel tank, and is provided in a fuel pipe for connecting the fuel tank and the fuel injection valve.

2. Description of the Conventional Art

A conventional in-line type fuel supply device is illustrated in FIG. 2.

Reference numeral 30 is a pump case formed in a sealing state by a lower case body 31 and an upper case body 32. A fuel intake passage 33 is opened at a lower end of the pump case 30, and a pump discharge passage 34 is opened at an upper end of the pump case 30.

A fuel pump P comprises a Westco type pump portion 36 having an impeller 35 and a motor portion 37 for rotating the impeller 35, and is provided in a cylindrical casing K. Further, a pump intake passage 38 connected with the pump portion 36 is opened toward a lower end in the right side of FIG. 2, and a pump discharge passage 39 is opened in a protruding manner toward an upper end in the left side of FIG. 2.

The fuel pump P is inserted and supported in the pump case 30 by a first support member 40 in the right side and a second support member 41 in the left side, where the first support member 40 has a pressing support piece portion 40a for pressing an outer circumference of the casing K. At this time, a cylindrical space 42 is formed between the casing K forming an outer circumference of the fuel pump P and an inner circumference of the pump case 30.

Further, the pump intake passage 38 of the fuel pump P is connected into a fuel flow-in chamber 44, which is formed at a right end of the pump case 30, through a filter 43, and the pump discharge passage 39 is inserted and supported in a pump discharge passage support hole 45 of the second support member 41. The pump discharge passage support hole 45 is connected to a fuel discharge passage 34, which is opened at a left end of the pump case 30, through a fuel flow-out chamber 46 formed at the left end of the pump case 30.

In addition, the cylindrical space 42 and the fuel flow-out chamber 46 are shut off by the second support member, and the fuel intake passage is opened in the fuel flow-in chamber 44. Further, reference numeral 47 is a fuel return passage connected to the cylindrical space 42.

Reference symbol R is a pressure regulator, and has the following structure.

Reference numeral 50 is a sectioning body held by a first casing body 51 and a second casing body 52. A fuel chamber 53 is formed with a right side surface of the sectioning body 50 and a recessed portion of the first casing body 51, and pressure chamber 54 is dividedly formed with a left side surface of the sectioning body 50 and a recessed portion of the second casing body 52.

Further, a regulator fuel flow-in hole 55 and a regulator fuel control hole 56 are opened in the fuel chamber 53, and a control valve 57 is provided facing to an opening end of the regulator fuel control hole toward the inside of the fuel chamber 53, where the control valve 57 is moved synchronously with the sectioning body 50.

Further, reference numeral 58 is a spring provided in contraction in the pressure chamber 54, and the sectioning body 50 including the control valve 57 is energized on the fuel chamber 53 side by the spring 58.

Further, the regulator fuel flow-in hole 55 is connected to the fuel flow-out chamber 46 of the pump case 30, and the regulator fuel control hole 56 is connected to the cylindrical space 42 of the pump case 30.

Further, a pressure pipe 59 opened on the pressure chamber 54 is connected to, for example, an intake passage on the downstream side from a throttle valve of a throttle body which is not illustrated in the drawings.

Further, the pump case 30 comprising the pressure regulator R and the fuel pump P is provided at the outside of the fuel tank, and connected by piping as follows.

The fuel intake passage 33 is connected with a fuel tank T by a first fuel pipe 60.

The fuel discharge passage 34 is connected toward a fuel injection valve J by a second fuel pipe 61.

Further, the fuel return passage 47 is connected with the fuel tank T by a third fuel pipe 62.

As described above, the fuel stored in the fuel tank T is supplied in the fuel flow-in chamber 44 through the first fuel pipe 60, to thereby fill the fuel flow-in chamber 44 with the fuel.

On the other hand, when the fuel pump P is driven, the fuel in the fuel flow-in chamber 44 is sucked to the pump portion 36 comprising the impeller 35 through a filter 43 and the pump intake passage 38, and increased in pressure by the pump portion 36. Then, the fuel increased in pressure passes through a motor space M between the outer circumference of the motor portion 37 and the inner circumference of the casing K, reaches the pump discharge passage 39, and is discharged to the fuel flow-out chamber 46 through the pump discharge passage support hole 45 of the second support member 41.

In this case, the fuel supplied into the fuel flow-out chamber 46 is supplied into the fuel chamber 53 through the regulator fuel flow-in hole 55. Further, the fuel filled in the fuel chamber 53 moves the control valve 57 to the left in the drawings through the sectioning body 50, is balanced with the spring 58 by a set pressure, and then, the opening of the regulator fuel control hole 56 is controlled by the control valve 57.

Thereby, the fuel in the fuel flow-out chamber 46 is controlled to be a predetermined fuel pressure.

Therefore, the fuel having the predetermined fuel pressure in the fuel flow-out chamber 46 can be supplied to the fuel injection valve J through the fuel discharge passage 34 of the pump case 30 and the second fuel pipe 61.

On the other hand, the fuel flowing in the regulator fuel control hole 56 is discharged into the cylindrical space 42 of the pump case 30, and the discharged fuel is flowed back to the fuel tank T through the fuel return passage 47 and the third fuel pipe 62.

### SUMMARY OF THE INVENTION

According to such the in-line type fuel supply device, the fuel increased in pressure by the pump portion 36 passes through the motor space M, and is supplied into the fuel chamber 53 of the pressure regulator R through the pump discharge passage 39, the pump discharge passage support hole 45 and the fuel flow-out chamber 46. Further, the fuel in the fuel chamber 53 is supplied into the cylindrical space 42 of the pump case 30 from the regulator fuel control hole 56. Furthermore, the fuel in the cylindrical space 42 is returned into the fuel tank T through the fuel return passage 47 and the third fuel pipe 62.

According to the above-described structure, the fuel flowing in the motor space M cools the outer circumference of the motor portion 37 of the fuel pump P to thereby control increasing of the temperature of the motor portion 37. Thereby, the fuel having absorbed the heat of the motor portion 37 to have a high temperature flows into the fuel chamber 53 of the pressureregulatorRfromthefuel flow-out chamber 46, and flows into the cylindrical space 42 through the regulator fuel control hole 56.

According to the above-described structure, the fuel having a high temperature flows into cylindrical space 42 between the outer circumference of the casing K and the inner circumference of the pump case 30, where the cylindrical space 42 is small. Thereby,much vapor is generated in the cylindrical space 42.

Further, much of the fuel including the vapor are returned to the fuel tank T through the fuel return passage 47 and the third fuel pipe 62. However, when the pump intake passage 38 and the cylindrical space 42 are not accurately maintained airtight by the first support member 40, a part of the vapor flowing in the cylindrical space 42 may be re-sucked to the pump portion 36 through the pump intake passage 38. Thereby, the pressure of the fuel discharged from the pump portion 36 cannot be increased enough. Further, the fuel supply becomes intermittent, so that there is a problem that a continuous and smooth fuel supply cannot be carried out.

Further, as illustrated in FIG. 2, the vapor maybe mixed into the fuel supplied from the fuel tank T to the fuel flow-in chamber 44, then the vapor stored in the fuel flow-in chamber 44 is often discharged into the cylindrical space 42 through a vapor discharge passage 65. However, the vapor produced in the cylindrical space 42 is eventually sucked into the fuel flow-in chamber 44 being in a negative pressure state, and the vapor is re-sucked to the pump portion 36, so that there is the same problem as described above.

Further, in this structure, the high temperature fuel having absorbed the heat of the motor portion 37 once flows at the outer circumference of the casing K of the fuel pump P, that is, in the cylindrical space 42, so that it is hard to effectively cool the motor portion 37. More particularly, in the in-line type fuel supply device, it is required that the fuel pump is provided very far from the heating part such as an engine or the like, or provided at a position easily receiving a travel wind, so that freedom of location of the fuel pump is limited.

The present invention solves the above-described problems, and an objective of the present invention is to provide an in-line type fuel supply device in a fuel injection device, in which vapor which is generated in a cylindrical space by regulator fuel returned from a regulator fuel control hole of a pressure regulator to a fuel tank, is not re-sucked to a pump portion of a fuel pump, to thereby enhance pump ability of the fuel pump, a motor portion of the fuel pump can be effectively cooled, to thereby enhance motor efficiency, further, vapor stored in a pump case is effectively discharged, and, furthermore, freedom of location of the fuel pump in the in-line type fuel supply device can be enhanced.

In one aspect of the in-line type fuel supply device in the fuel injection device of the present invention in order to obtain the above-described objective, the fuel supply device in the fuel injection device, in which the fuel in a fuel tank is increased in pressure by a fuel pump provided at the outside of the fuel tank, regulated in pressure at a predetermined fuel pressure by a pressure regulator, and supplied toward a fuel injection valve, is structured such that, the fuel pump is supported in a pump case surrounding an outer circumference of the fuel pump in such a manner as to have a cylindrical space, a pump intake passage of the fuel pump is provided and opened at a fuel flow-in chamber, which is formed at a lower end of the pump case, through a filter, a pump discharge passage of the fuel pump is inserted and connected to a fuel discharge passage formed at an upper end of the pump case, and a vapor discharge hole is opened at an upper space of the pump case connecting to the cylindrical space, that the pressure regulator is divided to a fuel chamber and a pressure chamber by a sectioning body, a regulator fuel flow-in hole and a regulator fuel control hole are opened in the fuel chamber, and a control valve for controlling the opening of the regulator fuel control hole is integrally provided at the sectioning body, and that the fuel discharge passage of the pump case is connected toward the fuel injection valve with a first fuel pipe, a second fuel pipe branched from the first fuel pipe is connected to the regulator fuel flow-in passage of the pressure regulator, the regulator fuel control hole is connected and opened in the fuel tank with a third fuel pipe, and the vapor discharge hole of the pump case is connected and opened in the fuel tank with a fourth fuel pipe.

Further, in another aspect of the present invention, in addition to the above-described aspect, a longitudinal axial line X-X of the fuel pump is provided to be inclined at an angle A of 45° or more upwardly with respect to a horizontal line Y-Y in the gravitational direction, and the vapor discharge hole is opened at an upper position in the gravitational direction than an upper space.

According to the one aspect of the present invention, the fuel in the fuel tank is supplied into the fuel flow-in chamber of the pump case through the fuel flow-in pipe, and the fuel in the fuel flow-in chamber is sucked to the pump portion of the fuel pump from the pump intake passage through the filter.

The fuel increased in pressure by the pump portion passes through the outer circumference of the motor portion, and is supplied to the fuel injection valve through the pump discharge passage, the fuel discharge passage and the first fuel pipe.

In this case, a part of the fuel flowing in the first fuel pipe is supplied into the fuel chamber of the pressure regulator through the second fuel pipe and the regulator fuel flow-in passage, and this fuel is regulated in pressure to a predetermined fixed fuel pressure. Thereby, the fuel regulated in pressure can be supplied from the first fuel pipe to the fuel injection valve.

On the other hand, surplus fuel generated by a pressure regulating action of the pressure regulator is discharged into the fuel tank through the regulator fuel control hole and the third fuel pipe.

As described above, when the fuel increased in pressure by the pump portion of the fuel pump passes through the motor portion, the fuel absorbs the heat produced at the motor portion to thereby increase the fuel temperature. However, the fuel having the increased temperature is supplied to the fuel injection valve through the first fuel pipe and further, returned to the fuel tank through the second fuel pipe, the pressure regulator, the regulator fuel control hole and the third fuel pipe. Thus, the fuel having the increased temperature is not directly re-supplied to the fuel pump.

Therefore, the motor portion of the fuel pump can be effectively cooled, to thereby enhance the motor efficiency.

Further, since the motor portion is effectively cooled, the fuel pump can be provided near the engine, so that the freedom of location of the fuel pump in the in-line type fuel supply device can be enhanced especially.

Further, the vapor may be mixed into the fuel flowing into the fuel flow-in chamber from the fuel tank through the fuel flow-in pipe. However, the vapor in the fuel flow-in chamber flows into the cylindrical space, and the vapor in the cylindrical space is discharged into the fuel tank through the upper space of the pump case, the vapor discharge hole and the forth fuel pipe. Thus, the vapor in the fuel flow-in chamber is not sucked to the pump portion of the fuel pump, the fuel can be accurately increased in pressure by the pump portion, and the fuel can be supplied continuously and smoothly.

Further, in the in-line type fuel supply device, since the fuel flows into the cylindrical space from the fuel flow-in chamber, the fuel in the cylindrical space receives the heat of the fuel pump, so that the vapor may be generated in the cylindrical space. However, the vapor generated in the cylindrical space is also discharged into the fuel tank through the fourth fuel pipe like the above-description. Thus, the vapor is not filled in the cylindrical space, and is not sucked to the pump portion of the fuel pump from the pump intake passage.

Further, according to the other aspect of the present invention, the fuel pump is provided to be inclined at an angle of 45° or more upwardly with respect to the horizontal line, and the vapor discharge hole is opened an the upper position in the gravitational direction than the upper space of the pump case. There by, vapor in the cylindrical space can be accurately collected in the upper space of the pump case, and the vapor can be accurately discharged from the forth fuel pipe to the fuel tank. Thus, discharge ability of the vapor in the cylindrical space can be enhanced, and the vapor in the cylindrical space is not sucked further into the fuel pump.

### BRIEF EXPLANATION OF DRAWINGS

FIG. 1 is a longitudinal sectional view illustrating one example of an in-line type fuel supply device in a fuel injection device of the present invention.

FIG. 2 is a longitudinal sectional view illustrating a conventional in-line type fuel supply device in a fuel injection device.

### DETAILED DESCRIPTION OF PREFERRED EMBODIMENT

Hereinafter, one example of the in-line type fuel supply device in the fuel injection device according to the present invention will be described with drawings.

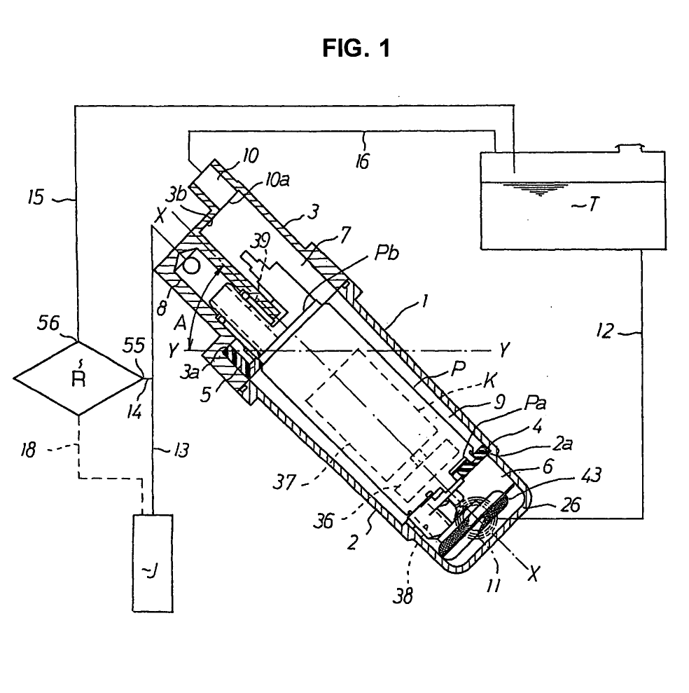

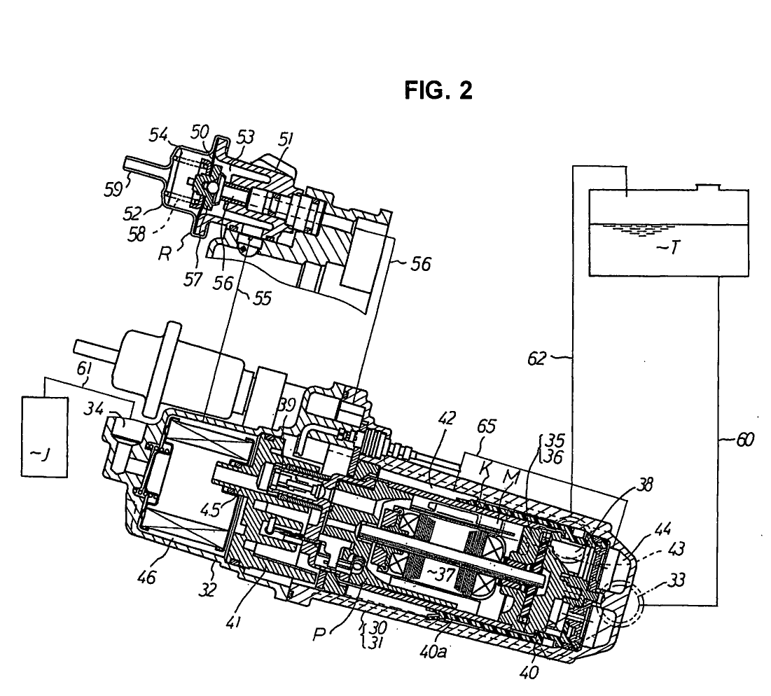

In this case, structures of a fuel pump and a pressure regulator used in FIG. 1 are same as those of FIG. 2, so that same reference numerals and symbols are used to thereby omit descriptions.

Reference numeral 1 is a pump case formed in a sealing state by a lower case body 2 and an upper case body 3. The lower case body 2 has a bottomed cylindrical shape having an opening upper portion, and the upper case body 3 has a bottomed cylindrical shape having an opening lower portion. Flange portions of both opening portions are contacted and provided.

A fuel pump P is held by a first support body 4 and a second support body 5 between a locking step portion 2a and a locking step portion 3a, where the locking step portion 2a faces to an upper part of the lower case body 2, and the locking step portion 3a faces to a lower part of the upper case body 3. At this time, a lower portion Pa of the fuel pump P having a pump intake passage 38 of the fuel pump P is provided so as to face to a fuel flow-in chamber 6 formed at a lower bottom portion 2b of the lower case body 2. An upper portion Pb of the fuel pump P is provided so as to face to an upper space 7 formed at an upper bottom portion 3b of the upper case body 3.

Further, the pump intake passage 38 of the fuel pump is connected into the fuel flow-in chamber 6 through a filter 43, and a pump discharge passage 39 projected upwardly from the upper portion Pb of the fuel pump P is inserted and connected to a fuel discharge passage 8 which is provided and opened downwardly in the upper case body 3.

Further, a cylindrical space 9 is continuously formed between the outer circumference of a casing K of the fuel pump P and the inner circumference of the lower case body 2. A lower part of the cylindrical space 9 is connected into the fuel flow-in chamber 6, and an upperpart of the cylindrical space 9 is connected to the upper space 7. Further, a vapor discharge hole 10 is opened on the upper bottom portion 3b of the upper case body 3 toward the upper space 7.

That is, the fuel flow-in chamber 6 is connected to the upper space 7 through the cylindrical space 9.

Further, the fuel intake passage 11 is opened in the fuel flow-in chamber 6 of the pump case 1, and the fuel intake passage 11 is connected to a bottom portion of the fuel tank T through the fuel flow-in pipe 12.

Further, the fuel discharge passage 8 is connected to the fuel injection valve J through a first fuel pipe 13.

Further, a regulator fuel flow-in hole 55 of a pressure regulator R is connected to a second fuel pipe 14 branched from the first fuel pipe 13, and a regulator fuel control hole 56 is connected to the fuel tank T through a third fuel pipe 15.

Furthermore, a vapor discharge hole 10 is opened and connected to the upper portion of the fuel tank T through a forth fuel pipe 16.

According to the above-described structure, the fuel in the fuel tank T is supplied toward the fuel flow-in chamber 6 of the pump case 1 through the fuel flow-in pipe 12, where the fuel flow-in chamber 6 is provided at a position being lower than the fuel tank T. The fuel stored in the fuel flow-in chamber 6 is sucked to a pump portion 36 through the filter 43 and the pump intake passage 38, and the fuel increased in pressure by the pump portion 36 passes through the outer circumference of a motor portion 37, and is supplied toward the fuel injection valve J through the pump discharge passage 39, the fuel discharge passage 8 and the first fuel pipe 13.

On the other hand, a part of the fuel flowing in the first fuel pipe 13 is supplied into the fuel chamber of the pressure regulator R through the second fuel pipe 14 and the regulator fuel flow-in hole 55, and is regulated in pressure at a predetermined fixed fuel pressure by a control valve 57.

Thereby, the pressure of the fuel flowing in the first fuel pipe 13 connected to the second fuel pipe 14 is also regulated at the predetermined fixed pressure, so that the fuel regulated in pressure is supplied to the fuel injection valve J through the first fuel pipe 13.

On the other hand, the surplus fuel regulated in pressure by the control valve flows down in the regulator fuel control hole 56, and is discharged into the fuel tank T through the third fuel pipe 15.

Further, in the fuel flowing in the fuel flow-in pipe 12, floating air and vapor are included, where the air is involved into the fuel by the vibration of the fuel tank T and the vapor is generated by the fuel flow-in pipe 12 heated by the surrounding. The vapor (including the air) maybe supplied into the fuel flow-in chamber 6 through the fuel flow-in pipe 12. However, the vapor flows into the cylindrical space 9 from the fuel flow-in chamber 6 by a self buoyancy, and is discharged into the fuel tank T through the upper space 7, the vapor discharge hole 10 and the fourth fuel pipe 16.

Accordingly, when the fuel increased in pressure by the pump portion 36 of the fuel pump P passes through the motor portion 37, the motor portion 37 is cooled, so that deterioration of rotation ability by increasing the temperature of the motor portion 37 can be prevented, and a pump ability can be sufficiently kept.

Further, in the pump portion 36, the fuel heated by the motor portion 37 once is not returned to the motor portion 37, and not contacted with the casing K of the motor portion 37 in contrast with the case of the conventional one. Thus, the temperature of the motor portion 37 is not remarkably increased and thus, a location to provide the fuel pump P is not limited. So, freedom of a location for the fuel pump P can be enhanced.

Further, since the casing K of the motor portion 37 is supplied with new fuel from the fuel tank T through the fuel flow-in pipe 12, increasing of the temperature of the fuel pump Pitself including the motor portion 37 can be prevented. Thereby, generating of the vapor in the fuel pump P can be prevented, and mixing of the vapor into the fuel flowing toward the fuel injection valve J from the first fuel pipe 13 can be prevented. Thus, the stable fuel can be supplied continuously from the fuel injection valve J.

Further, when the fuel including the vapor is supplied into the fuel flow-in chamber 6 from the fuel flow-in pipe 12, the vapor flows into the cylindrical space 9 immediately by the self buoyancy, so that the vapor is not stored in the fuel flow-in chamber 6. Thus, the vapor is not sucked to the pump portion 36 of the fuel pump P, and the stable fuel can be supplied continuously into the first fuel pipe 13.

On the other hand, the vapor flowing into the cylindrical space 9 flows into the upper space 7 immediately. The reason why the vapor flows into the upper space 7 immediately is that a cross-sectional area of the upper space 7 is larger than a cross-sectional area of the cylindrical space 9, so that the vapor can be flowed into the upper space 7 without resistance.

Further, when the fuel in the cylindrical space 9 is heated by the fuel pump P to thereby generate the vapor in the cylindrical space 9, the vapor flows into the upper space 7 like the above description.

Furthermore, a longitudinal axial line X-X of the fuel pump P is provided to be upwardly inclined at an angle A of 45° or more with respect to a horizontal line Y-Y in the gravitational direction, and an opening 10a of the vapor discharge hole 10 is opened at an upper position in the gravitational direction than the upper space 7. Therefore, the vapor easily flows into the upper space 7 from the cylindrical space 9, and the vapor flowing into the upper space 7 can be collected intensively in the upper space 7. Furthermore, the vapor can be effectively discharged into the fourth fuel pipe 16, to thereby more enhance the discharge ability of the vapor.

In addition, the first fuel pipe 13 can be connected to the regulator fuel flow-in hole 55 of the pressure regulator R, and the fuel chamber 53 and the fuel injection valve J can be connected with a fifth fuel pipe 18. The fifth fuel pipe 18 is indicated by a dotted line in this drawing.

What is claimed is,:

1. An in-line type fuel supply device in a fuel injection device, in which fuel in a fuel tank is increased in pressure by a fuel pump provided at the outside of the fuel tank, regulated in pressure to a predetermined fuel pressure by a pressure regulator, and supplied toward a fuel injection valve,
wherein a fuel pump is supported, in a pump case surrounding an outer circumference of the fuel pump in such a manner as to have a cylindrical space; a pump intake passage of the fuel pump is provided and opened at a fuel flow-in chamber, which is formed at a lower end of the pump case, through a filter; a pump discharge passage of the fuel pump is inserted and connected to a fuel discharge passage formed at an upper end of the pump case; and a vapor discharge hole is opened at an upper space of the pump case connecting to the cylindrical space,
wherein a pressure regulator is divided to a fuel chamber and a pressure chamber by a sectioning body; a regulator fuel flow-in hole and a regulator fuel control hole are opened in the fuel chamber; a control valve for controlling the opening of the regulator fuel control hole is integrally provided at the sectioning body, and
wherein the fuel discharge passage of the pump case is connected toward the fuel injection valve with a first fuel pipe, a second fuel pipe branched from the first fuel pipe is connected to the regulator fuel flow-in passage of the pressure regulator; the regulator fuel control hole is connected and opened in the fuel tank with a third fuel pipe, and the vapor discharge hole of the pump case is connected and opened in the fuel tank with a fourth fuel pipe.

2. The in-line type fuel supply device in the fuel injection device as claimed in claim 1, wherein a longitudinal axial line of the fuel pump is provided to be inclined at an angle of 45° or more upwardly with respect to a horizontal line in the gravitational direction, and the vapor discharge hole is opened at an upper position in the gravitational direction than an upper space.
